(19) United States
(12) Patent Application Publication
(10) Pub. No.: US 2026/0189507 A1
(43) Pub. Date: Jul. 2, 2026

(54) NETWORKING SYSTEM AND METHOD WITH MULTI-PORT ENDPOINT DEVICES

(71) Applicant: SAMSUNG ELECTRONICS CO., LTD., Suwon-si (KR)

(72) Inventors: Seokbin HONG, Suwon-si (KR); Yong In LEE, Suwon-si (KR); Wonseok LEE, Suwon-si (KR); Wonyoung LEE, Suwon-si (KR)

(73) Assignee: SAMSUNG ELECTRONICS CO., LTD., Suwon-si (KR)

(21) Appl. No.: 19/300,950

(22) Filed: Aug. 15, 2025

(30) Foreign Application Priority Data
Dec. 27, 2024 (KR) 10-2024-0199233

(51) Int. Cl. H04L 47/12; H04L 43/0852; H04L 47/11; H04L 47/31

(52) U.S. Cl. CPC H04L 47/12; H04L 43/0852; H04L 47/11; H04L 47/31

(57) ABSTRACT

A computer networking system includes a host, a switch connected to a root port of the host through an upstream port and including a plurality of downstream ports, and a plurality of endpoint devices connected to the switch and including a first endpoint device and a second endpoint device. The first endpoint device includes a first target port connected through a first downstream port of the plurality of downstream ports of the switch, a second target port connected through a second downstream port different from the first downstream port, and a controller configured to, in response to a request packet being received from the second endpoint device through the first target port, generate a response packet corresponding to the request packet, measure a first congestion level corresponding to the first target port and a second congestion level corresponding to the second target port, and transmit the response packet to the second endpoint device through an output port selected from among the first target port or the second target port based on a comparison of the measured first and second congestion levels.

### CROSS-REFERENCE TO RELATED APPLICATIONS

This application claims the benefit under 35 USC § 119(a) of Korean Patent Application No. 10-2024-0199233, filed on December 27, 2024, in the Korean Intellectual Property Office, the entire disclosure of which is incorporated herein by reference for all purposes.

### BACKGROUND

### 1. Field

The following description relates to a networking system and method with multi-port endpoint devices.

### 2. Description of Related Art

Peripheral Component Interconnect Express (PCIe) is a high-speed interconnect technology developed to enhance communication performance over the earlier PCI standard, which utilized a parallel communication architecture. In typical PCIe-based systems, there is a problem that a request path and a response path must be identical during peer-to-peer data transmission between endpoint devices. This is a limitation in that efficient path changes are not possible at the time of network congestion or overloading of a specific port, as the communication path is fixed once established. In particular, as the amount of data transmitted increases in a high-performance system, bottlenecks in specific ports frequently occur, which leads to a decrease in the overall system performance.

To solve such problems, there is a need to introduce an endpoint device that supports multiple ports and incorporate a technology capable of dynamically adjusting data transmission paths (e.g. packet routing) based on real-time monitoring of the status of each port.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one general aspect, a computer networking system includes a host; a switch connected to a root port of the host through an upstream port, the switch comprising a plurality of downstream ports; and a plurality of endpoint devices connected to the switch and comprising a first endpoint device and a second endpoint device, wherein the first endpoint device includes a first target port connected to a first downstream port of the switch; a second target port connected to a second downstream port different from the first downstream port; and a controller configured to, in response to receiving a request packet from the second endpoint device through the first target port, generate a response packet corresponding to the request packet, measure a first congestion level for the first target port and a second congestion level for the second target port, and transmit the response packet to the second endpoint device through an output port selected from among the first target port or the second target port based on a comparison of the measured first and second congestion levels.

The controller may be configured to match tag information included in the received request packet with tag information included in the generated response packet; determine packet transmission latencies for the first and second target ports, respectively, based on the matched tag information; and measure the first and second congestion levels based on the determined latencies.

The controller may be configured to measure the first and second congestion levels based on a number of response packets corresponding to request packets received from the second endpoint device, among the request packets transmitted from the first endpoint device to the second endpoint device.

The controller may be configured to determine one or both of first port identification information corresponding to the first target port and second port identification information corresponding to the second target port as output port identification information corresponding to the output port by inputting packets related to the first and second congestion levels into a decoder; and store the output port identification information in a lookup table based on configuration information received from the host.

The first endpoint device may be configured to generate tag information based on a generation time point of each of a plurality of response packets comprising the response packet.

The first endpoint device may be configured to, in response to receiving another request packet from the second endpoint device after receiving the request packet, generate another response packet corresponding to the other request packet and generate additional tag information based on a generation time point of the other response packet, and the controller is configured to align transmission time points of the response packet and the other response packet to another endpoint device based on the tag information and the additional tag information.

At least one of the first target port or the second target port may include a first sub-port comprising a first transaction layer, a first data link layer, and a first physical layer, and configured to transmit configuration information received from the host to an internal register; and a second sub-port comprising a second transaction layer and a second data link layer.

The second endpoint device may be configured to generate metadata comprising source information corresponding to the second endpoint device and destination information corresponding to the first endpoint device; and transmit the generated metadata and the request packet to the first endpoint device.

The first endpoint device may be configured to transmit the request packet and the metadata to the second endpoint device through the output port, and the second endpoint device is configured to track a peer-to-peer communication path between the first and second endpoint devices based on the metadata.

The source information may include identification information corresponding to the second endpoint device and a target port included in the second endpoint device, and the destination information comprises identification information corresponding to the first endpoint device and a target port included in the first endpoint device.

In one general aspect, a computer networking method includes receiving, by a first endpoint device comprising a first target port and a second target port, a request packet from a second endpoint device through the first target port; generating, by the first endpoint device, a response packet corresponding to the request packet; measuring, by a controller included in the first endpoint device, a first congestion level corresponding to the first target port and a second congestion level corresponding to the second target port; selecting, by the controller, an output port from among the first target port and the second target port based on a comparison of the measured first and second congestion levels; and transmitting, by the controller, the response packet to the second endpoint device through the selected output port.

The measuring of the first and second congestion levels may include matching tag information included in the received request packet with tag information included in the generated response packet; determining packet transmission latencies for the first and second target ports, respectively, based on the matched tag information; and measuring the first and second congestion levels based on the determined latencies.

The measuring of the first and second congestion levels may include measuring the first and second congestion levels based on a number of response packets corresponding to request packets received from the second endpoint device, among the request packets transmitted from the first endpoint device to the second endpoint device.

The selecting of the output port may include determining one or both of first port identification information corresponding to the first target port and second port identification information corresponding to the second target port as output port identification information corresponding to the output port by inputting packets related to the first and second congestion levels into a decoder; and storing, by the controller, the output port identification information in a lookup table based on configuration information received from the host.

The method may further include generating, by the first endpoint device, tag information based on a generation time point of the response packet.

The method may further include, in response to receiving another request packet from the second endpoint device after a time point of receiving the request packet, generating, by the first endpoint device, another response packet corresponding to the other request packet; generating, by the first endpoint device, additional tag information based on a generation time point of the other response packet; and aligning, by the controller, transmission time points of the response packet and the other response packet to another endpoint device based on the tag information and the additional tag information.

The method may further include generating, by the second endpoint device, metadata comprising source information corresponding to the second endpoint device and destination information corresponding to the first endpoint device; and transmitting, by the second endpoint device, the generated metadata and the request packet to the first endpoint device.

The method may further include transmitting, by the first endpoint device, the request packet and the metadata to the output port; and tracking, by the second endpoint device, a peer-to-peer communication path between the first and second endpoint devices based on the metadata.

The generating of the metadata may include generating, by the second endpoint device, source information comprising identification information corresponding to the second endpoint device and a target port included in the second endpoint device; and generating, by the second endpoint device, destination information comprising identification information corresponding to the first endpoint device and a target port included in the first endpoint device.

In one general aspect, provided is a non-transitory computer-readable storage medium storing instructions that, when executed by one or more processors, cause the one or more processors to perform the method described herein.

Other features and aspects will be apparent from the following detailed description, the drawings, and the claims.

### BRIEF DESCRIPTION OF THE DRAWINGS

FIG. 1 illustrates an example computer networking system according to one or more embodiments.

FIGS. 2 and 3 illustrate respective example endpoint device including a plurality of ports according to one or more embodiments.

FIG. 4 illustrates an example computer networking method according to one or more embodiments.

FIG. 5 illustrates an example controller according to one or more embodiments.

FIG. 6 illustrates an example operation of measuring a congestion level for each target port using a port monitor in a controller according to one or more embodiments.

FIG. 7 illustrates an example method of determining an output port for moving data using a port management unit in a controller according to one or more embodiments.

FIG. 8 illustrates an example method of determining a target port, through which data is to be transmitted or received, based on a congestion level of each target port by endpoint devices including a plurality of target ports, according to one or more embodiments.

FIGS. 9 and 10 illustrate respective example transmission of data between endpoint devices including a plurality target ports in a computer networking system according to one or more embodiments.

FIGS. 11 and 12 illustrate a scenario in which communication is performed between endpoint devices even when a movement path of data is changed based on a plurality of endpoint devices in a computer networking system according to one or more embodiments.

Throughout the drawings and the detailed description, unless otherwise described or provided, the same drawing reference numerals may be understood to refer to the same or like elements, features, and structures. The drawings may not be to scale, and the relative size, proportions, and depiction of elements in the drawings may be exaggerated for clarity, illustration, and convenience.

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of the disclosure of this application. For example, the sequences of operations described herein are merely examples, and are not limited to those set forth herein, but may be changed as will be apparent after an understanding of the disclosure of this application, with the exception of operations necessarily occurring in a certain order. Also, descriptions of features that are known after an understanding of the disclosure of this application may be omitted for increased clarity and conciseness.

The features described herein may be embodied in different forms and are not to be construed as being limited to the examples described herein. Rather, the examples described herein have been provided merely to illustrate some of the many possible ways of implementing the methods, apparatuses, and/or systems described herein that will be apparent after an understanding of the disclosure of this application.

The terminology used herein is for describing various examples only and is not to be used to limit the disclosure. The articles "a," "an," and "the" are intended to include the plural forms as well, unless the context clearly indicates otherwise. As used herein, the term "and/or" includes any one and any combination of any two or more of the associated listed items. As non-limiting examples, terms "comprise" or "comprises," "include" or "includes," and "have" or "has" specify the presence of stated features, numbers, operations, members, elements, and/or combinations thereof, but do not preclude the presence or addition of one or more other features, numbers, operations, members, elements, and/or combinations thereof.

Throughout the specification, when a component or element is described as being "connected to," "coupled to," or "joined to" another component or element, it may be directly "connected to," "coupled to," or "joined to" the other component or element, or there may reasonably be one or more other components or elements intervening therebetween. When a component or element is described as being "directly connected to," "directly coupled to," or "directly joined to" another component or element, there can be no other elements intervening therebetween. Likewise, expressions, for example, "between" and "immediately between" and "adjacent to" and "immediately adjacent to" may also be construed as described in the foregoing.

Although terms such as "first," "second," and "third", or A, B, (a), (b), and the like may be used herein to describe various members, components, regions, layers, or sections, these members, components, regions, layers, or sections are not to be limited by these terms. Each of these terminologies is not used to define an essence, order, or sequence of corresponding members, components, regions, layers, or sections, for example, but used merely to distinguish the corresponding members, components, regions, layers, or sections from other members, components, regions, layers, or sections. Thus, a first member, component, region, layer, or section referred to in the examples described herein may also be referred to as a second member, component, region, layer, or section without departing from the teachings of the examples.

Unless otherwise defined, all terms, including technical and scientific terms, used herein have the same meaning as commonly understood by one of ordinary skill in the art to which this disclosure pertains and based on an understanding of the disclosure of the present application. Terms, such as those defined in commonly used dictionaries, are to be interpreted as having a meaning that is consistent with their meaning in the context of the relevant art and the disclosure of the present application and are not to be interpreted in an idealized or overly formal sense unless expressly so defined herein. The use of the term "may" herein with respect to an example or embodiment, e.g., as to what an example or embodiment may include or implement, means that at least one example or embodiment exists where such a feature is included or implemented, while all examples are not limited thereto.

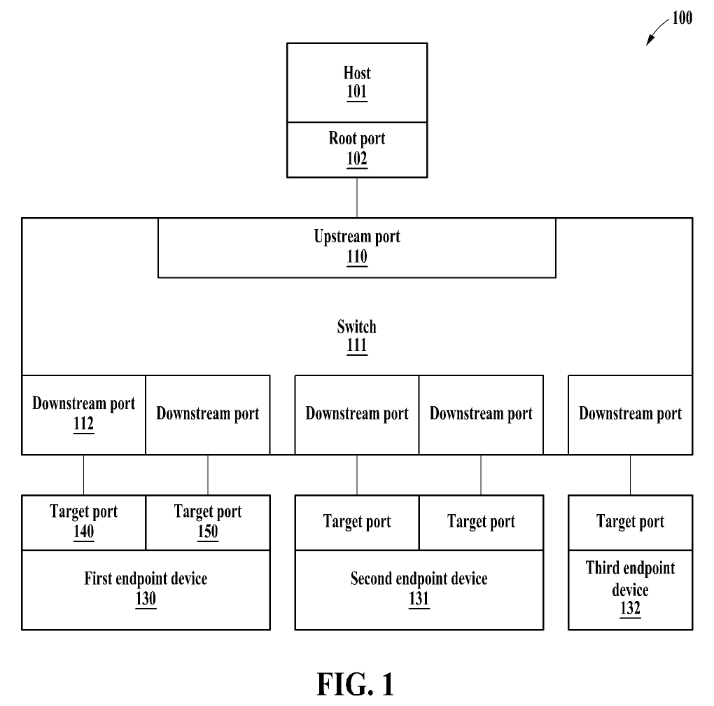

FIG. 1 illustrates an example computer networking system according to one or more embodiments.

A computer networking system 100 (hereinafter, “system 100”) may include a device that supports a computer interconnection technology. For example, the system 100 may include a Peripheral Component Interconnect Express (PCIe) device designed to enable high-performance data communications and efficient interconnection among devices. The system 100 may transmit data (e.g., in the form of packet) between a host 101 and various peripheral devices, such as a first endpoint device 130, a second endpoint device 131, and a third endpoint device 132, as shown in of FIG. 1. The system 100 may include the host 101, a switch 111, and a plurality of endpoint devices (e.g., devices 130, 131, and 132 of FIG. 1). The host 101 may control data transmission within the system 100, and may include a root port 102 that may operate as a bridge between the host 101 and the remaining endpoint devices in the system 100. The root port 102 may serve as the primary interface for communicating between the host 101 and other endpoint devices, managing memory access transactions and data transmission between the host 101 and the endpoint devices. Additionally, the root port 102 may control enumeration and configuration processes to discover and initialize the endpoint devices in the system 100. The host 101 may initialize a bus of the system 100 through the root port 102. For example, the host 101 may transmit memory read and/or write requests to the endpoint devices connected to the host 101 through the switch 111. Also, the host 101 may receive response data from the endpoint devices. The host 101 may be implemented, for example, using a central processing unit (CPU).

The switch 111 may include an upstream port 110 connected to the root port 102 of the host 101, and a plurality of downstream ports 112 connected to target ports 140 of respective endpoint devices. The system 100 may control a movement path of data (e.g., a packet) based on the switch 111. For example, the switch 111 may select a downstream port to transmit a packet received from the host 101 through the upstream port 110 to a desired endpoint device. For example, the switch 111 may turn on or off the downstream port 112 corresponding to the movement path of the packet. For example, when the system 100 transmits data from the host 101 to the first endpoint device 130, the switch 111 may turn on the downstream port 112 connected to the first endpoint device 130. For example, when the system 100 transmits data from the host 101 to the second endpoint device 131, the switch 111 may turn on a downstream port connected to the second endpoint device 131. For example, when the system 100 transmits data from the host 101 to the third endpoint device 132, the switch 111 may turn on a downstream port connected to the third endpoint device 132.

The system 100 may perform adaptive routing by turning on or off appropriate ports when performing peer-to-peer communication between different endpoint devices based on the switch 111. For example, when transmitting a packet from the first endpoint device 130 to the second endpoint device 131 in the system 100, the switch 111 may turn on both the target port 140 of the first endpoint device 130 and the target port of the second endpoint device 131.

The endpoint devices (e.g., devices 130, 131, and 132 of FIG. 1) may be physical devices that are connected to a computer network and exchange information with the computer network. Examples of endpoint device may include a memory device (e.g., a dynamic random access memory (DRAM)) and a storage device (e.g., a solid state disk (SSD)), but are not limited thereto. Each endpoint device may be connected to the switch 111. For example, the first endpoint device 130 may be connected to the downstream port 112 of the switch 111 through the target port 140. The first endpoint device 130 may receive a request packet (e.g., a packet that requests memory read) from the host 101 through the target port 140. The first endpoint device 130 may include a plurality of target ports (e.g., target ports 140 and 150). For example, the first endpoint device 130 may include a first target port and an N-th target port. Here, N is an integer greater than or equal to 2. Similarly, the second endpoint device 131 and the third endpoint device 132 may each include a plurality of target ports. For example, the first endpoint device 130 may perform peer-to-peer communication with another endpoint device (e.g., the second endpoint device 131 or the third endpoint device 132) through at least one of the target port 140 or the target port 150.

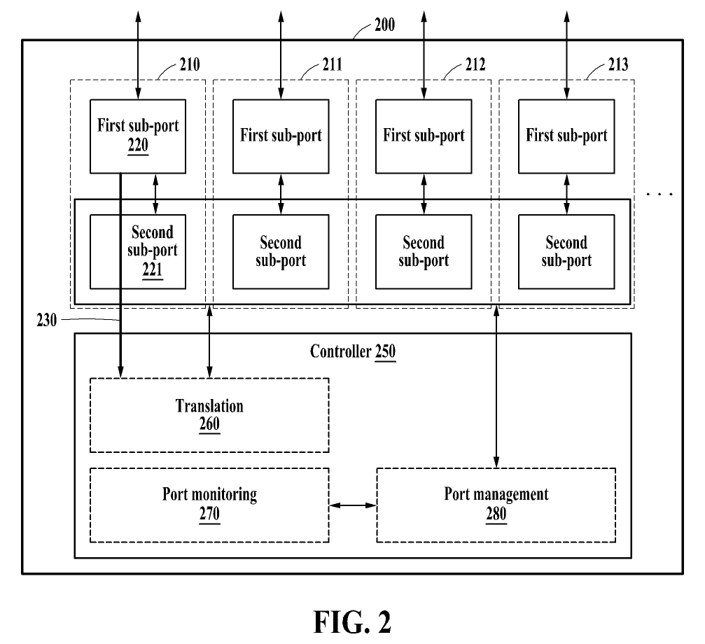

The endpoint device including a plurality of target ports will be described below in detail with reference to FIG. 2. In examples where the endpoint devices each include multiple target ports, when data is transmitted from one endpoint device (e.g., the first endpoint device 130) to another endpoint device (e.g., the second endpoint device 131 or the third endpoint device 132), the system 100 may select a target port to be used for data transmission from among the target ports included in each endpoint device. A port having a high congestion level at any time point may result in poor communication efficiency if this port is selected, since it is being used to transmit (transport) a packet at that time point. For example, the port having a high congestion level at any time point may indicate that data is moving through the corresponding port at any time point. Therefore, the endpoint device may select which target port the packet is to be transmitted through, in order to increase the communication efficiency between endpoint devices.

For reference, in First Comparative Example, the PCIe technology is performed based on point-to-point communication, and therefore First Comparative Example may be difficult to apply to a plurality of endpoint devices. Also, in First Comparative Example, a request path and a response path are necessarily identical based on the PCIe technology. For example, in First Comparative Example, a request path, through which a request packet is transmitted from the host 101 to the first endpoint device 130, and a response path for the request path are identical. By contrast, the system 100 according to one or more embodiments may support adaptive routing by utilizing endpoint devices with multiple target ports in combination with the switch 111, thereby allowing flexible and efficient packet transmission paths.

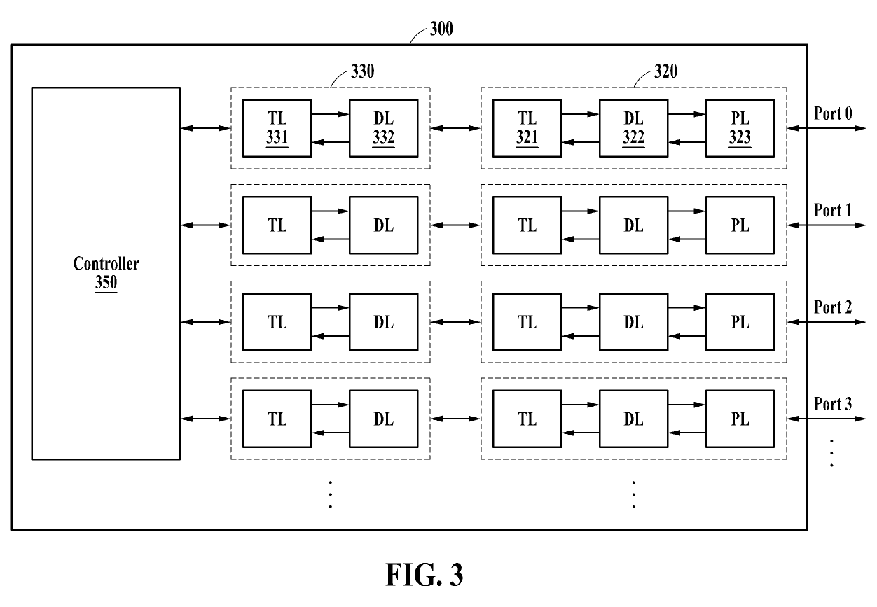

FIGS. 2 and 3 illustrate respective example endpoint device including a plurality of ports.

Referring to FIG. 2, an endpoint device 200 (e.g., device 130, the second endpoint 131, or 132 of FIG. 1) may be a physical device connected to a computer network and configured to exchange information over the computer network. For example, the endpoint device 200 may include one or more memory devices, storage devices, And/or processing components such as a graphics processing unit (GPU), an SSD, and/or a network interface card (NIC), without limitation.

The endpoint device 200 may include a plurality of target ports 210, 211, 212, and 213 as well as a controller 250. For example, the endpoint device 200 may include a first target port 210, a second target port 211, a third target port 212, and a fourth target port 213. Although FIG. 2 illustrates four target ports, the number of ports may vary, and the endpoint device 200 may include N target ports, where N is an integer greater than or equal to 2. The endpoint device 200 may be connected to a switch (e.g., the switch 111 of FIG. 1) through the plurality of target ports 210, 211, 212, and 213. For example, the endpoint device 200 may be connected to a first downstream port of the switch through a first target port. The endpoint device 200 may be connected to a second downstream port of the switch through a second target port. The endpoint device 200 may be connected to a third downstream port of the switch through a third target port, and may be connected to a fourth downstream port of the switch through a fourth target port.

At least one of the target ports 210, 211, 212, and 213 may include a plurality of sub-ports. For example, the first target port 210 may include a first sub-port 220 and a second sub-port 221. The other target ports (e.g., the second to fourth target ports 211 to 213) may similarly include multiple sub-ports. For simplicity, the following description focuses on the first target port 210. The first sub-port 220 included in the first target port 210 may receive configuration information 230 from a host and transmit it to a register file (not shown) within the endpoint device 200. The first sub-port 220 may also be referred to as an upstream port of the endpoint device 200. The second sub-port 221 may also be referred to as an embedded endpoint port, and may be implemented in software as a virtual port in the endpoint device 200. The specific structures of the first sub-port 220 and the second sub-port 221 will be described below with reference to FIG. 3.

The endpoint device 200 may transmit and receive data to and from a host (e.g., the host 101 of FIG. 1) or other endpoint devices via the target ports 210 - 213. Each target port (e.g., the first target port 210) may be functionally divided into the physical sub-port (e.g., 220) and a virtual sub-port (e.g., 221). The endpoint device 200 may transmit the configuration information 230 (e.g., a configuration packet) received from the host through the first sub-port 220 to an internal register file of the endpoint device 200. For example, the endpoint device 200 may include a configuration space and an extended configuration space. The endpoint device 200 may include various register files in the extended configuration space. For example, the endpoint device 200 may include a register file, such as a vendor-specific extended capability, in the extended configuration space. Also, the endpoint device 200 may store in advance information indicating whether the endpoint device 200 includes a multi-port in the extended configuration space. In addition, the endpoint device 200 may include a control and status register (CSR) in the extended configuration space to manage control and status information of the endpoint device 200.

When the configuration information 230 is received from the host, the endpoint device 200 may provide data included in the configuration space and the extended configuration space to the host, thereby enabling the host to recognizet that the endpoint device 200 includes and supports multiple target ports. In addition, a lookup table may be established within the endpoint device 200 based on host interaction. Also, the endpoint device 200 may use the first and second sub-ports 220 and 221 as data paths for transmitting and receiving data (e.g., a request packet or a response packet) to and from the host and/or other endpoint devices.

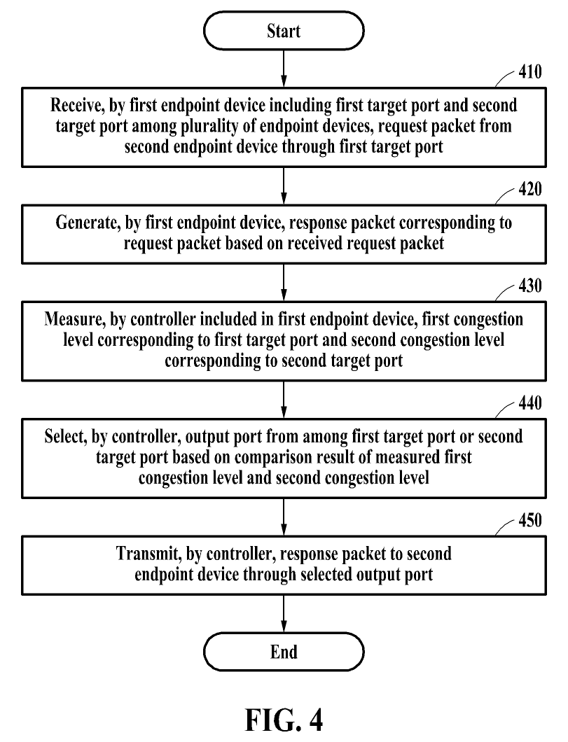

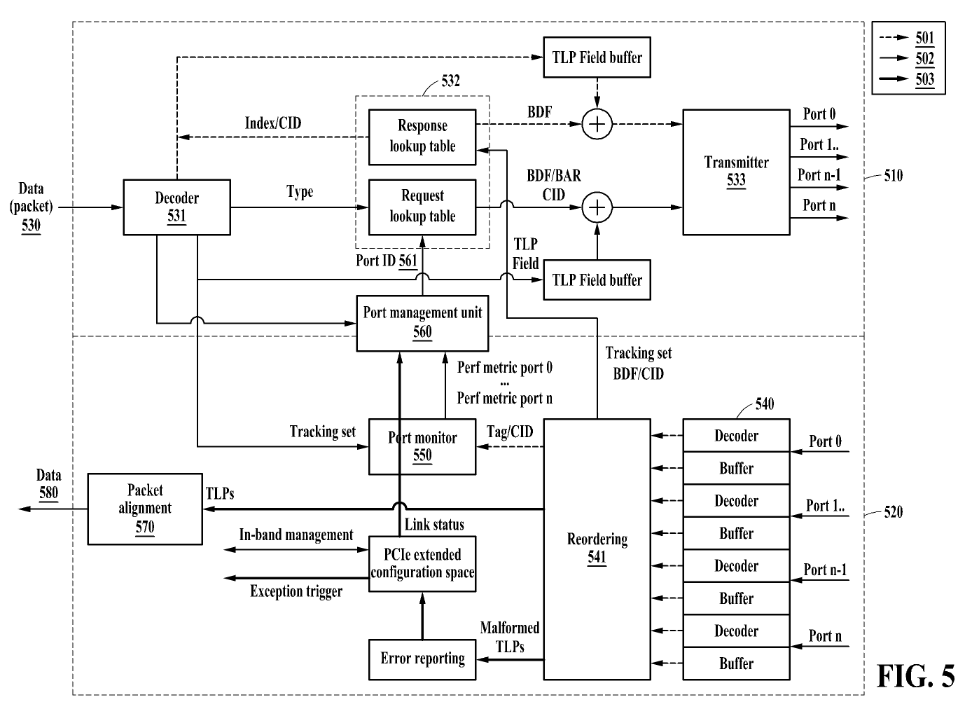

The endpoint device 200 may include the controller 250, which may process data received through the target ports 210 through 213 of the endpoint device 200 and determine an appropriate target port for transmitting the processed data from among the target ports 210 to 213. For example, when the endpoint device 200 receives a request packet from another endpoint device through the first target port 210, the controller 250 may generate a corresponding response packet for the request packet. For example, the controller 250 may perform a translation operation 260 for the request packet. In the translation operation 260, the controller 250 may convert an address, a bus, a device, and a function included in the request packet. For example, in the translation operation 260, the controller 250 may convert a global address included in the request packet into a local address within the endpoint device. For example, in the translation operation 260, the controller 250 may generate a response packet in which the bus, device, function (BDF) of the request packet is mapped to each target port. The controller 250 needs to select a target port to be used for data transmission, in order to transmit the generated response packet to another endpoint device. For example, in a port monitoring operation 270, the controller 250 may measure congestion levels of the target ports 210 to 213. For example, the controller 250 may measure a first congestion level corresponding to the first target port 210 and a second congestion level corresponding to the second target port 211. In a port management operation 280, the controller 250 may compare the first congestion level and the second congestion level. The controller 250 may select a target port having a low congestion level as an output port of the response packet based on a comparison result of the first congestion level and the second congestion level. The endpoint device 200 may transmit the response packet to another endpoint device, to which the request packet is transmitted, through the output port selected by the controller 250. A more detailed explanation of selecting a target port to be used for transmitting a response packet by the controller 250 will be described below with reference to FIGS. 4 and 5.

In FIG. 3, an endpoint device 300 (e.g., the endpoint devices 130, 131, 132, or 200 of FIGS. 1 and 2) may include multiple target ports (e.g., ports 0 to 3). While FIG. 3 illustrates four ports, additional ports may also be supported. Each of the target ports included in the endpoint device 300 may have the same structure or different structures. For example, at least one target port included in the endpoint device 300 may include multiple sub-ports. For example, some target ports included in the endpoint device 300 may include two sub-ports such as a first sub-port 320 and a second sub-port 330, while other target ports may not include sub-ports. The following description focuses on target ports that include distinct sub-port structures.

The endpoint device 300 may include a first target port (e.g., port 0) and a controller 350. The first target port may include the first sub-port 320 (e.g., sub-port 220 of FIG. 2) and the second sub-port 330 (e.g., sub-port 221 of FIG. 2). The first sub-port 320 may include a first transaction layer 321, a first data link layer 322, and a first physical layer 323.

The first transaction layer 321 may be configured to process transaction requests and responses. For example, the first transaction layer 321 may generate and manage memory read/write requests, input and output (I/O) requests, and configuration access requests. The first transaction layer 321 may set a destination of data based on an address of a packet and tag information (e.g., a tag field) included in the packet. The first data link layer 322 may detect errors in data received from the first transaction layer 321. When an error is detected, the first data link layer 322 may request the first transaction layer to retransmit data. The first physical layer 323 may represent a layer that converts received data into an actual electrical signal and transmits the electrical signal.

The first sub-port 320 may serve as an upstream port and may transmit configuration information (e.g., a configuration packet) received from the host to the controller 350. The second sub-port 330 may include a second transaction layer 331 and a second data link layer 332. The second sub-port 330 may not include a physical layer, unlike the first sub-port 320. The second sub-port 330 may be a port embedded in the endpoint device 300 and may be implemented through software.

The endpoint device 300 may transmit processed data (e.g., a response packet) from the first sub-port 320 to the controller 350 through the second sub-port 330. The controller 350 may determine/select, as an output port, a target port which is most suitable for transmitting a response packet (e.g., a target port having a lowest congestion level) among the plurality of target ports (e.g., ports 0 to 3) included in the endpoint device 300. The controller 350 may transmit a response packet to another endpoint device through the selected output port.

FIG. 4 illustrates an example computer networking method according to one or more embodiments. In operation 410, a computer networking system (e.g., the system 100 of FIG. 1) may transmit a request packet of a second endpoint device to a first endpoint device, which includes a first target port and a second target port. From the perspective of the first endpoint device, the first endpoint device may receive a request packet from the second endpoint device through the first target port.

In operation 420, the first endpoint device included in the computer networking system may generate a response packet corresponding to the request packet based on the received request packet. For example, the first endpoint device may analyze/interpret type information, address information, and tag information included in the request packet. Based on this analzsis, the first endpoint device may generate the response packet by transforming the type information and the address information and mapping the tag information of the request packet to tag information of the response packet. The response packet may include data to be transmitted to the endpoint device which has transmitted the request packet.

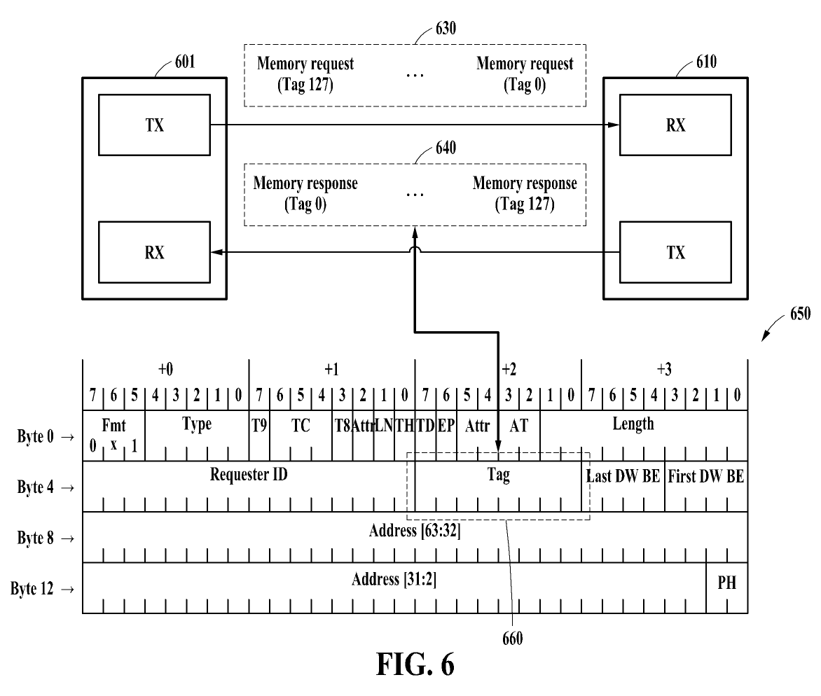

In operation 430, the first endpoint device may manage a plurality of target ports using an internal controller. For example, the controller may measure a first congestion level corresponding to the first target port and a second congestion level corresponding to the second target port. For example, the controller may measure the first congestion level corresponding to the first target port and the second congestion level corresponding to the second target port based on a port monitor. The port monitor may be implemented in hardware or software (e.g., performing a port monitoring operation 270 of FIG. 2). The port monitor may be referred to as a performance monitor. For example, the controller may measure a round trip latency based on the tag information included in the received request packet and the tag information included in the generated response packet. In another example, the controller may determine the congestion levels of the target ports by measuring bus utilization or a bandwidth of each target port. The method of measuring the congestion level of the target port by the controller will be described in detail below with reference to FIGS. 6 through 8.

In operation 440, the controller included in the first endpoint device may compare the measured first congestion level and second congestion level, and select an output port based on the comparison result of the first congestion level and the second congestion level. For example, the controller may select a target port having a lowest congestion level as the output port based on a port management operation 280 of FIG. 2.

In operation 450, the controller included in the first endpoint device may transmit the response packet to the endpoint device, which has transmitted the request packet, through the selected output port. For example, it is assumed that the second endpoint device transmits a request packet to the first endpoint device, and the first endpoint device generates the response packet based on the request packet. Since the request packet is received from the second endpoint device, the first endpoint device needs to transmit the response packet corresponding to the request packet to the second endpoint device. For example, the controller may transmit the response packet to the same target port as the target port, through which the first endpoint device has received the request packet. In another example, the controller may compare the congestion level of the target port, through which the first endpoint device has received the request packet, with the congestion level of other target ports, and transmit the response packet through the target port having the lowest congestion level.

FIG. 5 illustrates an example of a controller according to one or more embodiments.

A controller 500 may include a transmission unit 510 and a reception unit 520. For example, the transmission unit 510 may process data received from another endpoint device to transmit transformed data back to the other endpoint device. The transmission unit 510 may be referred to as a data space. For example, the reception unit 520 may classify/sort data based on data received from another endpoint device and determine a port, through which the data is to be transmitted to the other endpoint device. The reception unit 520 may be referred to as a control space.

The controller 500 may process data 530 (e.g., a request packet) transmitted from another endpoint device along a response path 501, a request path 502, and a common path 503. For example, when a response to the data 530 is transmitted to another endpoint device based on the data 530, the controller 500 may process the data 530 based on the response path 501 and the common path 503. In another example, the controller 500 may transmit the request packet generated from the endpoint device including the controller 500 to another endpoint device based on the request path 502 and the common path 503.

The controller 500 may analyze the data 530 received from another endpoint device using a decoder 531. For example, the controller 500 may extract an index/component ID (CID), a type field, a tracking set, and a transaction layer packet (TLP) field corresponding to the data 530 by inputting the data 530 to the decoder 531. The index/CID may represent information that identifies which device or port the data 530 has been transmitted from. The type field may indicate the type or command type of the data 530. For example, the type field may indicate information that distinguishes whether the data 530 is a request packet or a response packet received from another endpoint device. The tracking set may represent information for tracking the status of the data 530 and managing request-response matching. For example, the tracking set may indicate at which point the data 530 has been transmitted and at which point the data 530 has arrived at an endpoint device including the controller 500. The controller 500 may transmit the index/CID extracted through the decoder 531 to a TLP field buffer along the response path 501.

The controller 500 may extract BDF information of the corresponding data 530 based on the index/CID from a lookup table 532. The controller 500 may combine the BDF information of the data 530 and the information transmitted through a TLP field buffer, and transmit it to a transmitter 533. The transmitter 533 of the controller 500 may generate data (e.g., a packet) to be transmitted to another endpoint device, which has transmitted the data 530, based on the input data. The method of forming the lookup table 532 by the controller 500 will be described in detail below.

The controller 500 may form the lookup table 532 based on configuration information (e.g., a configuration packet) received from a host (e.g., the host 101 of FIG. 1). The lookup table 532 may include a response lookup table and a request lookup table. For example, when the request packet is transmitted, the controller 500 may store pieces of information related to a transmission path in the request lookup table. For example, the controller 500 may store a memory address range included in a request packet, information on a target port to which the request packet is to be transmitted, and BDF information of the request packet in the request lookup table. In another example, when the response packet is transmitted, the controller 500 may store information required for matching the request packet in the response lookup table. For example, the controller 500 may store tag information included in the request packet, the BDF information of the endpoint device that has transmitted the request packet, and the information indicating a processing status (e.g., success or error) of the request packet in the response lookup table. However, the structure and contents of the lookup table may be user-defined and are not limited to the examples above.

The controller 500 may receive data from multiple endpoint devices through respective ports. For example, the controller 500 may receive data from four different endpoint devices through four corresponding ports, each of which includes the controller 500. For example, the reception unit 520 of FIG. 5 may include multiple decoder and buffer pairs 540. Each decoder and buffer pair 540 may be connected 1:1 to each port of the endpoint device including the controller 500. For example, the controller 500 may receive data from a second endpoint device through a first target port (e.g., the port 0), and receive data from a third endpoint device through a second target port (e.g., the port 1).

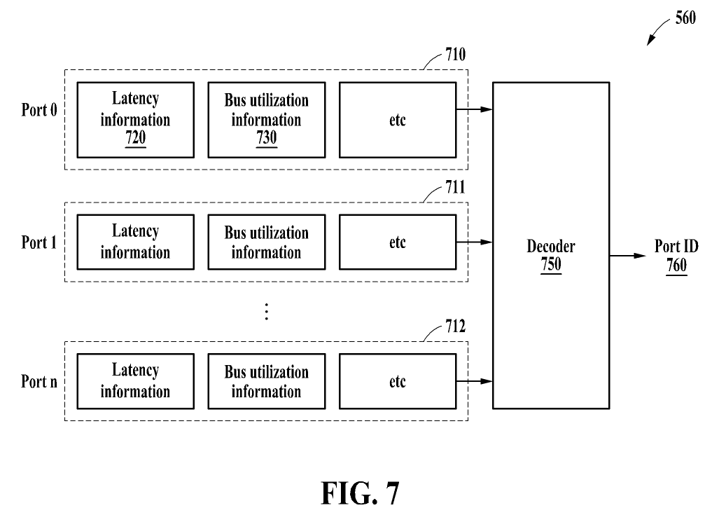

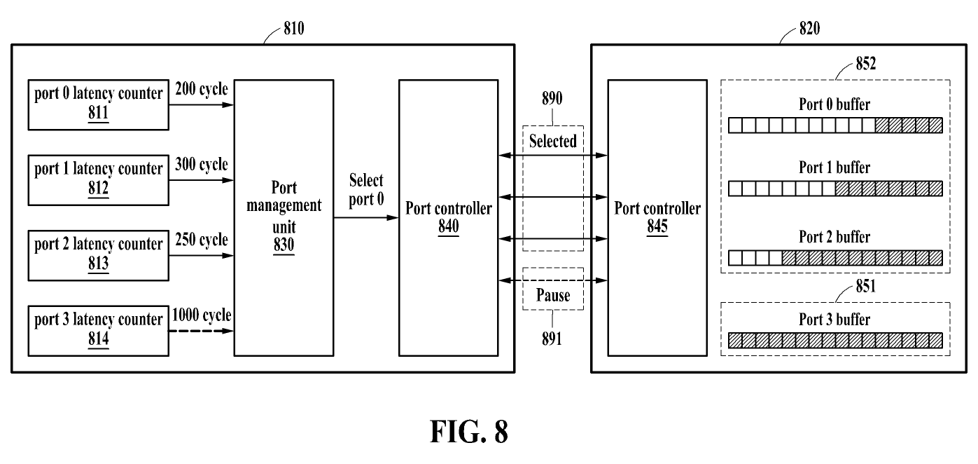

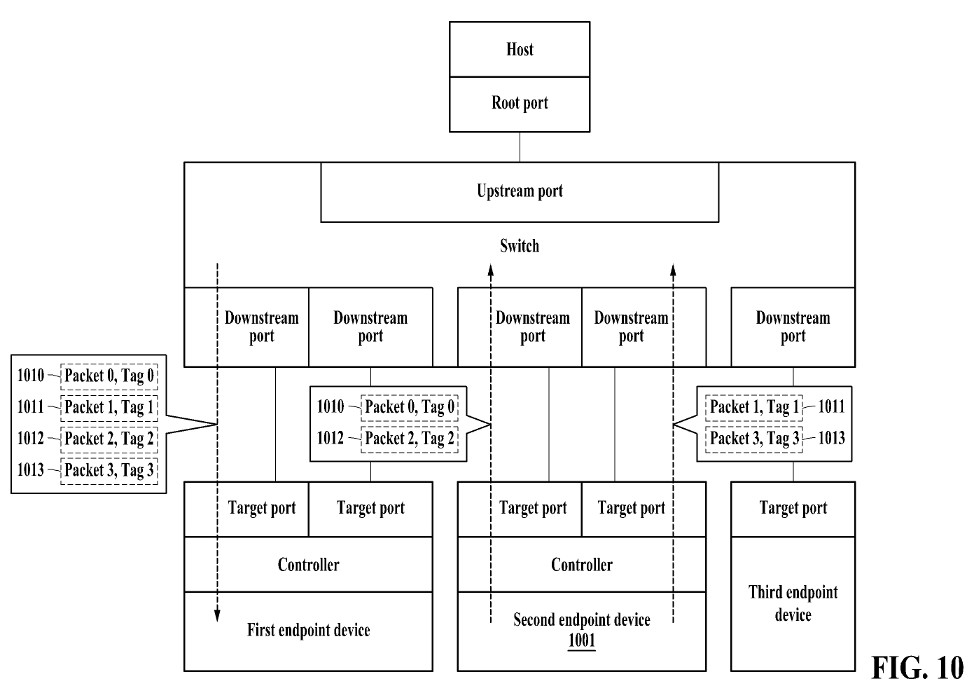

In operation 541, the controller 500 may reorder the pieces of data received from the different endpoint devices in the input order. The controller 500 may store the pieces of reordered data in the lookup table 532. The method of reordering pieces of data by the controller 500 will be described below with reference to FIG. 10. The controller 500 may input the Tag/CID (e.g., tag information and component ID) of each data extracted by reordering the pieces of data to a port monitor 550. For example, the port monitor 550 may identify terminated transactions based on Tag/CID and update a performance indicator value. The port monitor 550 may measure a congestion level of each of a plurality of target ports included in the endpoint device. The controller 500 may transmit the congestion level of each of the target ports measured based on the port monitor 550 to a port management unit 560. The port management unit 560 may store a port ID 561 corresponding to a target port for transmitting the data to another endpoint device in the lookup table 532 based on the transmitted congestion levels of the target ports. The operation of the port monitor 550 will be described in detail below with reference to FIG. 6, and the operation of the port management unit 560 will be described in detail below with reference to FIGS. 7 and 8.

The controller 500 may detect and extract malformed data (e.g., malformed TLPs) based on the pieces of data reordered in operation 541, and perform error reporting based on the malformed data. The controller 500 may extract a link status for each target port by inputting an error reporting result into a PCIe extended configuration space. The controller 500 may transmit the link status of each target port to the port management unit 560. The port management unit 560 may extract the port ID 561 corresponding to a target port to be used for data transmission based on the link status of each target port and the congestion level of each target port measured by the port monitor 550. The controller 500 may determine the target port corresponding to the port ID 561 as the output port of the data. The controller 500 may issue data 580 to be transmitted to another endpoint device by inputting each of the reordered data into packet alignment 570.

In summary, the controller 500 may monitor the status/condition of target ports included in the endpoint device using the port monitor 550. Based on congestion levels measured by the port monitor 550, the controller 500 may determine the optimal target port for data transmission via the port management unit 560. The controller 500 may obtain an address and a BDF value from the lookup table 532 and transmit the data to the target port determined by the port management unit 560.

FIG. 6 illustrates an example operation of measuring a congestion level for each target port using a port monitor in a controller according to one or more embodiments.

Referring to FIG. 6, different endpoint devices 601 and 610 in a computer networking system may transmit and receive data. FIG. 6 illustrates an example data transmission and reception between a first endpoint device 601 and a second endpoint device 610, in which the second endpoint device 610 receives a request packet 630 (e.g., a memory request) generated by the first endpoint device 601 via a path extending from a target port (e.g., TX) of the first endpoint device 601 to a target port (e.g., RX) of the second endpoint device 610. The second endpoint device 610 generates a response packet 640 (e.g., a memory response) corresponding to the request packet 630 received from the first endpoint device 601, and transmits the response packet 640 back to the first endpoint device 601 0 through a return path from the target port (e.g., TX) of the second endpoint device 610 to the target port (e.g., RX) of the first endpoint device 601.

For example, it is assumed that, when the first endpoint device 601 and the second endpoint device 610 transmit and receive data to and from each other, a movement path of one piece of data may transmit and receive the data through one port included in each endpoint device. For example, when the first endpoint device 601 transmits one request packet to the second endpoint device 610, one of the plurality of target ports included in the first endpoint device 601 may be used. Also, when the second endpoint device 610 receives the request packet from the first endpoint device 601, one of the plurality of target ports included in the second endpoint device 610 may be used. In other words, since the first endpoint device 601 and the second endpoint device 610 may transfer the data to each other through one target port, a movement path of the data between the first endpoint device 601 and the second endpoint device 610 may be identified through an address of each target port.

The request packet 630 and the response packet 640 may have a predetermined data format 650. For example, the predetermined data format 650 may include Fmt information, Type information, Length information, Request ID information, tag information 660, and address information indicating whether data is included. For example, when the first endpoint device 601 generates a total of 128 request packets 630, each request packet 630 may include different tag information (e.g., Tag 0 to Tag 127) depending on a generation time point. Also, when the second endpoint device 610 generates a total of 128 response packets 640, each response packet 640 may include different information (e.g., Tag 0 to Tag 127) depending on the generation time point.

Each of the first endpoint device 601 and the second endpoint device 610 may include a controller. The following description is mainly provided based on the processing data from the perspective of the second endpoint device 610. For example, a controller (e.g., the controller 250 of FIG. 2, 350 of FIG. 3, or 500 of FIG. 5) in the second endpoint device 610 may include a port monitor (e.g., the port monitor 550 of FIG. 5). The controller may determine a congestion level for each target port of the second endpoint device 610 based on measurements taken by the port monitor.

For example, the controller may match the tag information 660 included in the request packet 630 received from the first endpoint device 601 and the tag information 660 included in the response packet 640 generated in response to the request packet 630. The controller may identify the target port, through which the request packet 630 is received, by matching the tag information 660 included in the request packet 630 and the tag information 660 included in the response packet 640. For example, the controller may determine packet transmission latencies corresponding to each of the target ports based on the matched tag information via the port monitor. For example, the controller may match the tag information 660 included in the request packet 630 and the tag information 660 included in the response packet 640 to measure a round trip latency corresponding to an error between a time point at which the request packet 630 is transmitted from the first endpoint device 601 and a time point at which the response packet 640 is transmitted from the second endpoint device 610. The controller may identify a target port on the movement path of the request packet 630 and the response packet 640 by matching the request packet 630 and the response packet 640, and may measure the congestion level of each target port by measuring the latency of data movement through the target port.

Although not illustrated in FIG. 6, the controller of the first endpoint device 601 may measure the congestion levels of target ports by tracking the number of response packets 640 corresponding to the request packets 630 received from the second endpoint device 610 among the request packets 630 transmitted from the first endpoint device 601 to the second endpoint device 610. The controller of the first endpoint device 601 may measure the number of response packets 640 returned among the plurality of request packets 630 transmitted through the target port, for each target port included in the first endpoint device 601. For example, when the first endpoint device 601 transmits a total of 10 request packets 630 through the first target port, the controller of the first endpoint device 601 may measure the number of response packets 640 received corresponding to the request packet 630. In addition, when the first endpoint device 601 transmits a total of 10 request packets 630 through the second target port, the controller of the first endpoint device 601 may measure the number of response packets 640 received corresponding to the request packets 630. The controller of the first endpoint device 601 may measure the congestion level of each target port based on an outstanding request value of the response packet 640 compared to the request packet 630. The controller may compare the number of response packets 640 received to the number of request packets 630 of each target port, and determine the congestion level of a target port which has received relatively fewer response packets 640 as a high congestion level. A similar process can be repeated for other target ports. The control unit may thus infer congestion levels by comparing the ratio of request-to-response packets per port, identifying ports with lower response rates as more congested.

FIG. 7 illustrates an example method of determining an output port for moving data using a port management unit in a controller according to one or more embodiments.

Referring to FIG. 7, the controller may include a port management unit 560, which includes a decoder 750. The port management unit 560 may receive packet information 710, 711, and 712 for each target port from a port monitor (e.g., the port monitor 550 of FIG. 5). For example, the endpoint device may include ports 0 through n, where n is an integer greater than or equal to 1. The port monitor may receive the packet information 710 corresponding to the port 0, the packet information 711 corresponding to the port 1, and the packet information 712 corresponding to the port n. The packet information 710, 711, and 712 may indicate information related to the congestion level of each target port. For example, the packet information 710 may include latency information 720 and bus utilization information 730 corresponding to the port 0. Similarly, the packet information 711 and the packet information 712 may include latency information and bus utilization information corresponding to each of target ports (e.g., the port 1 and the port n). The port management unit 560 may determine identification information corresponding to the target port having the lowest congestion level as output port identification information 760 corresponding to the output port based on the packet information 710, 711, and 712 corresponding to each target port being input to the decoder 750. The controller may store the output port identification information 760 determined from the port management unit 560 in a lookup table based on configuration information being received from the host.

FIG. 8 illustrates an example method of determining a transmission or reception target port based on congestion levels across multiple ports of endpoint devices according to one or more embodiments.

Referring to FIG. 8, a first endpoint device 810 serves as a source device that transmits a request packet to a second endpoint device 820, which serves as a target device. The first endpoint device 810 may include four target ports (e.g., ports 0 - 3). The first endpoint device 810 may include latency counters 811 - 814 connected to each of the four target ports. For example, the first endpoint device 810 may measure latency for each port based on the latency counters 811 - 814 connected to each of the four different target ports. As illustrated in FIG. 8, the first endpoint device 810 may measure a latency value of 200 cycles corresponding to a first target port based on the first latency counter 811. In the same manner, the first endpoint device 810 may measure a latency value of 300 cycles, a latency value of 250 cycles, and a latency value of 1,000 cycles corresponding to the second target port to the fourth target port, respectively, based on the second through fourth latency counters 812 - 814. The first endpoint device 810 may input the latency value for each port to a port management unit 830. The port management unit 830 may extract identification information of the fourth target port having the highest latency value. Alternatively, the port management unit 830 may extract identification information of the first target port with the smallest latency value.

The first endpoint device 810 may include a port controller 840. The port controller 840 may pause transmission and reception of data through the fourth target port based on the identification information of the fourth target port extracted from the port management unit 830. In another example, the port controller 840 may select the first target port as a port, through which data is to be transmitted, based on the identification information of the first target port extracted from the port management unit 830.

The second endpoint device 820 may serve to receive the data from the first endpoint device 810. The second endpoint device 820 may include a controller, and buffers corresponding to a plurality of target ports. For example, the second endpoint device 820 may include four buffers corresponding to first through fourth target ports (e.g., ports 0 - 3 buffers). The second endpoint device 820 may determine a storage status of each of the plurality of target port buffers based on the controller. For example, a storage status 851 of the buffer corresponding to the fourth target port included in the second endpoint device 820 may be considered as full compared to a storage status 852 of the buffers corresponding to the first target port to the third target port. The second endpoint device 820 may measure the congestion level of the fourth target port to be higher than the congestion levels of other target ports (e.g., the ports 0 - 3) based on the storage status 852 of the buffer corresponding to the fourth target port. The second endpoint device 820 may pause transmission and reception of data through the fourth target port included in the second endpoint device 820 by inputting the storage statuses 851 and 852 for each of the plurality of target ports to a port controller 845. In addition, the second endpoint device 820 may transmit and receive data through the first target port of the second endpoint device 820 with the smallest number of pieces of stored data by inputting the storage status 852 for each of the plurality of target ports to the port controller 845.

In summary, as illustrated in FIG. 8, the first endpoint device 810 and the second endpoint device 820 may select at least one of paths 890 using the first through third target ports (e.g., ports 0-2) to transmit and/or receive the data. On the other hand, the first endpoint device 810 and the second endpoint device 820 may not select a path 891 using the fourth target port (e.g., port 3), due to a high congestion level, as a path for transmitting and/or receiving the data.

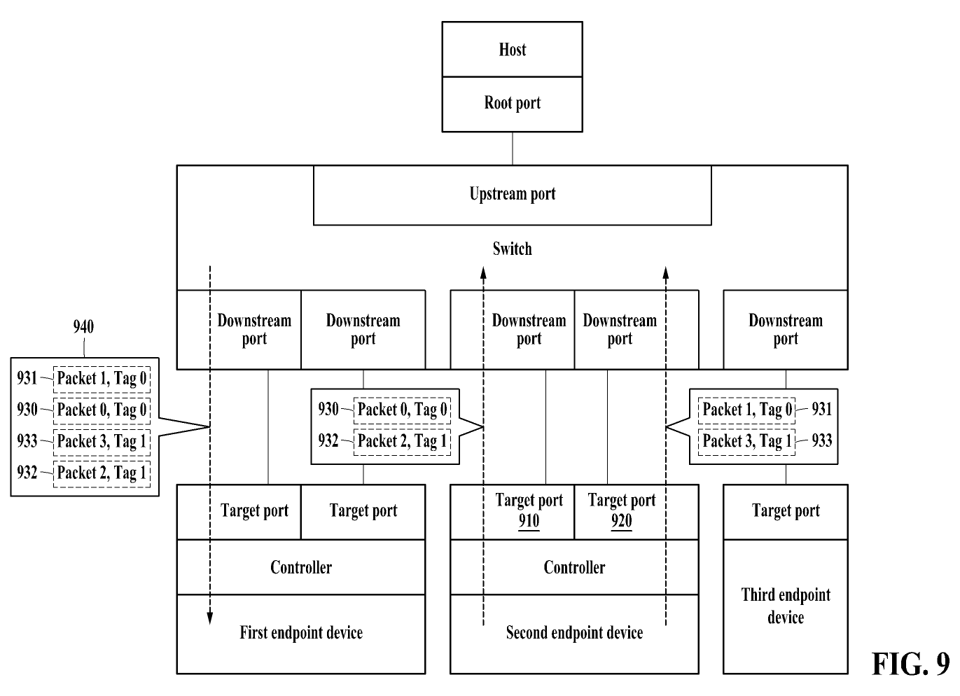

FIGS. 9 and 10 illustrate respective example transmission of data between endpoint devices that each includes a plurality target ports in a computer networking system according to one or more embodiments.

Referring to FIG. 9, a data transmission between endpoint devices according to Second Comparative Example is illustrated. Second Comparative Example may include a first endpoint device and a second endpoint device, each including a plurality of target ports. The second endpoint device included in Second Comparative Example may generate data 930, 931, 932, and 933 to be transmitted to the first endpoint device. The second endpoint device may add tag information to the data 930, 931, 932, and 933 for each target port, through which the data 930, 931, 932, and 933 is to be moved. In other words, the second endpoint device may add the tag information based on the order of data passing through the target port from the perspective of the target port. For example, the second endpoint device may add the tag information to the data 930 and 932 passing through a target port 910 based on the order of the data passing through the target port 910. For example, the second endpoint device may add the tag information corresponding to a tag 0 to the data 930 passing through the target port 910, and add the tag information corresponding to a tag 1 to the data 932 passing through the target port 910 after the data 930. In another example, the second endpoint device may add the tag information corresponding to the tag 0 to the data 931 passing through a target port 920, and add the tag information corresponding to the tag 1 to the data 933 passing through the target port 920 after the data 931. The second endpoint device included in Second Comparative Example may transmit the data 930, 931, 932, and 933 to the first endpoint device through the plurality of target ports 910 and 920. The second endpoint device may transmit the data 930, 931, 932, and 933 to the first endpoint device via multiple paths through the plurality of target ports 910 and 920. It is assumed that the data 930, 931, 932, and 933 are transmitted through the same target port of the first endpoint device. Referring to FIG. 9, a first case 940 in which the data 930, 931, 932, and 933 are transmitted through the target port of the first endpoint device is illustrated. In Second Comparative Example, the data 930, 931, 932, and 933 need to be sequentially transmitted to the first endpoint device. As illustrated in the first case 940 of FIG. 9, although the data is intended to be delivered in sequence, the reception order at the first endpoint device is disordered – for example, the data 931 is transmitted to the first endpoint device before the data 930, and the data 933 is transmitted to the first endpoint device before the data 932. Therefore, the first case 940 may indicate a state in which the order of transmission of the data 930, 931, 932, and 933 to the first endpoint device is disordered. The second endpoint device of Second Comparative Example attaches the tag information to each data transmitted from the target port based on the target port, and thus, the same tag information may be attached to the data transmitted through different target ports. Because of this, when the data arrives out of order, as in the first case 940, the system cannot properly restore the original sequence based solely on the tag information.

Referring to FIG. 10, an example of a computer networking system (e.g., the system 100 of FIG. 1) implementing improved data transmission between the endpoint devices is shown. In this example, a second endpoint device 1001 may generate corresponding tag information based on a generation time point of each of a plurality of pieces of data 1010, 1011, 1012, and 1013. For example, the second endpoint device 1001 generates the data 1010, the data 1011, the data 1012, and the data 1013 in this order. The second endpoint device 1001 may generate tag information corresponding to the tag 0 based on the generation time point of the data 1010 which is generated first among the data 1010, 1011, 1012, and 1013. The second endpoint device 1001 may generate tag information corresponding to the tag 1 based on the generation time point of the data 1011 generated after the generation of the data 1010. Similarly, the second endpoint device 1001 may generate tag information (e.g., the tag 2, the tag 3) corresponding to each of the data 1012 and the data 1013 generated after the generation of the data 1011. The second endpoint device 1001 may add the generated tag information to the corresponding data. Thus, unlike in Second Comparative Example, where the tag information is added to each target port based on the order of data transmitted through each target port, in this example the tag information may be added based on the order of the generation of the data for each second endpoint device. Therefore, the pieces of data generated from one endpoint device may have different tag information, enabling the receiving device to reorder the packets correctly based on tag order, regardless of the transmission path used. As a result, the data 1010, 1011, 1012, and 1013 transmitted to the first endpoint device via multiple paths through the plurality of target ports of the second endpoint device 1001 may be transmitted to the first endpoint device based on the order of tag information.

Although not directly illustrated in FIG. 10, the second endpoint device 1001 may also receive other data, such as a request packet, after receiving data from the first endpoint device. The second endpoint device 1001 may generate data (e.g., a response packet) corresponding to the received data. In such cases, when the other request packet is additionally received, the second endpoint device 1001 may generate another response packet corresponding to the other request packet. The second endpoint device 1001 may generate other tag information based on the generation time point of the other response packet. A controller (not shown) included in the second endpoint device 1001 may reorder data by aligning the time points, at which the pieces of data are to be transmitted to the first endpoint device, based on tag information and other tag information corresponding to previously generated data.

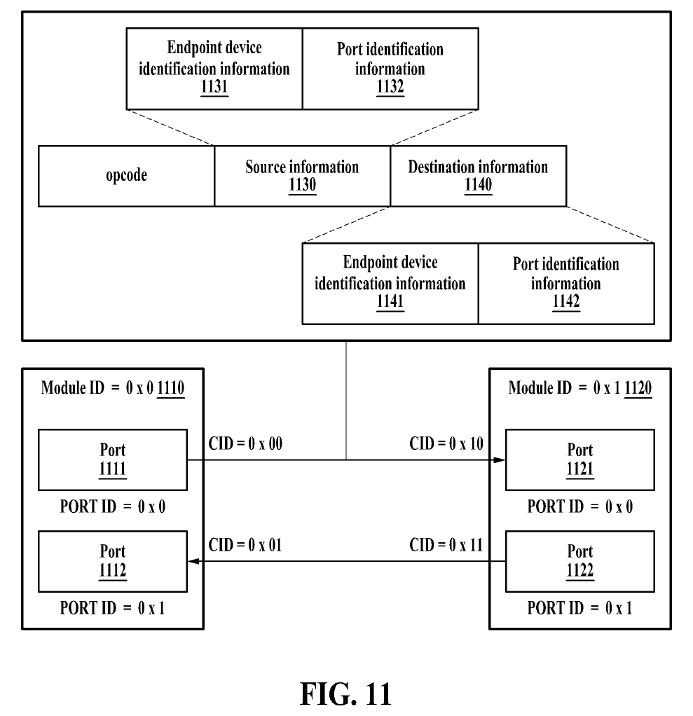

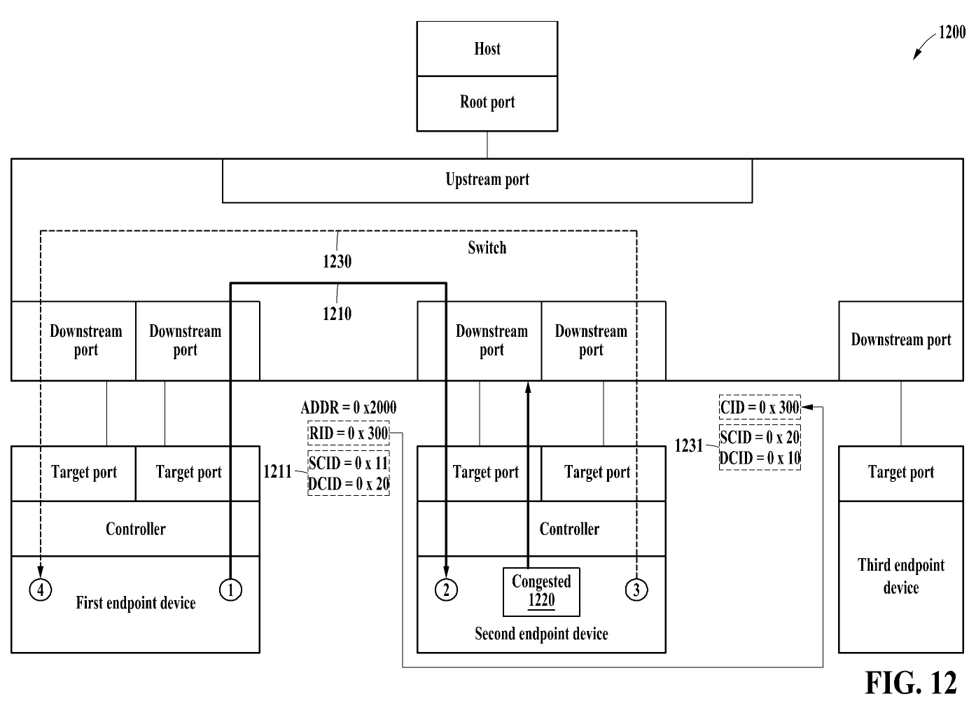

FIGS. 11 and 12 illustrate respective scenarios in which data communication is performed between endpoint devices, even when a data movement path is changed based on a plurality of endpoint devices in a computer networking system, according to one or more embodiments.

Referring to First Comparative Example of FIG. 1, when data (e.g., a packet) is transmitted based on the PCIe technology, a request path and a response path should be identical. In First Comparative Example, the data is transmitted and received through a single path, simplifying the determination of whether data communication is established between endpoint devices.

In contrast, in the computer networking system described herein, a target port, through which the data is transmitted from one endpoint device, may be different from a target port, through which response data to the transmitted data is received. Accordingly, even when the target port for the data transmission and the target port for the data reception of the endpoint device on the computer networking system are different, a new data format is required to determine whether peer-to-peer communication is successfully established.

Referring to FIG. 11, a first endpoint device 1110 may transmit data (e.g., a request packet) to a second endpoint device 1120 via a target port 1111. The second endpoint device 1120 may receive data from the first endpoint device 1110 via a target port 1121, and generate data (e.g., a response packet) corresponding to the data. The second endpoint device 1120 may transmit the generated data (e.g., the response packet) to the first endpoint device 1110 via a target port 1122 other than the target port 1121, through which the data is received. The first endpoint device 1110 may receive the data from the second endpoint device 1120 via a target port 1112 other than the target port 1111, through which the data is initially transmitted.

In summary, the first endpoint device 1110 may use the target port 1111 for transmitting the data and the target port 1112 for receiving the data, while the second endpoint device 1120 may use the target port 1121 for receiving the data and the target port 1122 for transmitting the data. Since the endpoint devices 1110 and 1120 transmit and receive the data to and from each other through different target ports 1111 and 1112, or 1121 and 1122, in order to determine whether the data has departed from a desired endpoint device and has arrived an endpoint device corresponding to a destination, the computer networking system require additional information to verify that the data has reached its intended destination.

For example, assuming that the data is transmitted from the first endpoint device 1110 to the second endpoint device 1120 in FIG. 11, the first endpoint device 1110 may represent a source device corresponding to the data, and the second endpoint device 1120 may represent a destination device corresponding to the data. On the other hand, assuming that the data is transmitted from the second endpoint device 1120 to the first endpoint device 1110, the second endpoint device 1120 may correspond to a source device and the first endpoint device 1110 may correspond to a destination device. Hereinafter, the description will be provided based on a case where the first endpoint device 1110 is a source device and the second endpoint device 1120 is a destination device.

The first endpoint device 1110 may have source information 1130. For example, the source information may include unique identification information 1131 corresponding to the first endpoint device 1110 and port identification information 1132 corresponding to a target port, through which the data is to be transmitted. For example, the identification information 1131 of the first endpoint device 1110 may indicate "Module ID = 0 × 0." When the first endpoint device 1110 transmits the data through the target port 1111, the port identification information 1132 may indicate "PORT ID = 0 × 0." Similarly, the second endpoint device 1120 may have destination information 1140. For example, the destination information 1140 may include unique identification information 1141 corresponding to the second endpoint device 1120 receiving the data, and port identification information 1142 corresponding to a target port for receiving data. For example, the identification information 1141 of the second endpoint device 1120 may indicate "Module ID = 0 × 1." When the second endpoint device 1120 receives the data through the target port 1121, the port identification information 1142 may indicate "PORT ID = 0 × 0." Before transmitting the data to the second endpoint device 1120, the first endpoint device 1110 may generate metadata including the source information 1130 corresponding to the source device and the destination information 1140 corresponding to the destination device. The first endpoint device 1110 may transmit data together with the metadata to the second endpoint device 1120, thereby causing the second endpoint device 1120 to identify the endpoint device, which has transmitted the data.

FIG. 12 illustrates a scenario in which a computer network system 1200 (e.g., the system 100 of FIG. 1) establishes data communication between endpoint devices including a plurality target ports according to one or more embodiments.

In the system 1200, a first endpoint device may transmit a request packet (e.g., ADDR = 0 × 2000, BDF = 0 × 310, and request ID (RID) = 0 × 300) to a second endpoint device through a first path 1210. Along with the request packet, the first endpoint device may transmit metadata 1211 including source information (e.g., SCID = 0 × 11) and destination information (e.g., DCID = 0 × 20) to the second endpoint device through the first path 1210.

In operation 1220, the second endpoint device may measure congestion levels of target ports included in the second endpoint device using a controller. In FIG. 12, the description is provided mainly based on a case where a congestion level of a target port on the first path 1210 among the target ports of the second endpoint device is higher than congestion levels of other target ports.

The second endpoint device may generate a response packet based on the request packet and the associated metadata received through the first path 1210. While the second endpoint device may generate the response packet by converting BDF information and ADDR information included in the request packet in accordance with the PCIe protocol, the second endpoint device may retain RID = 0 × 300 from the request packet and use it as completer ID (CID) = 0 × 300 in the response packet. The second endpoint device may maintain a CID value as an RID value of the request packet. The second endpoint device may transmit metadata 1231 including source information (e.g., SCID = 0 × 20) and destination information (e.g., DCID = 0 × 10) from the perspective of the second endpoint device, along with the response packet, to the first endpoint device through a second path 1230. The first endpoint device may receive the response packet and the metadata transmitted from the second endpoint device through the second path 1230.

Referring to FIG. 12, the target port, through which the first endpoint device transmits the request packet, is different from the target port, through which the first endpoint device receives the response packet. The first endpoint device may track a peer-to-peer communication path with the second endpoint device based on the metadata transmitted along with the response packet. For example, the first endpoint device may establish the peer-to-peer communication through the plurality of target ports by matching the source information and the destination information included in the metadata generated by the first endpoint device with the destination information and the source information of the metadata generated by the second endpoint device based on control logic within the respective controllers.

The processors, the memories, controllers, and other apparatuses, devices, units, and components described herein, including descriptions with respect to respect to FIGS. 1-12, are implemented by or representative of hardware components. As described above, or in addition to the descriptions above, examples of hardware components that may be used to perform the operations described in this application where appropriate include controllers, sensors, generators, drivers, memories, comparators, arithmetic logic units, adders, subtractors, multipliers, dividers, integrators, and any other electronic components configured to perform the operations described in this application. In other examples, one or more of the hardware components that perform the operations described in this application are implemented by computing hardware, for example, by one or more processors or computers. A processor or computer may be implemented by one or more processing elements, such as an array of logic gates, a controller and an arithmetic logic unit (ALU), a digital signal processor (DSP), a microcomputer, a programmable logic controller, a field-programmable gate array (FPGA), a programmable logic array (PLU), a microprocessor, or any other device or combination of devices that is configured to respond to and execute instructions (e.g., code or coding) in a defined manner to achieve a desired result. In one example, a processor or computer includes, or is connected to, one or more memories storing the instructions or software that are executed by the processor or computer. Hardware components implemented by a processor or computer may execute the instructions or software, such as an operating system (OS) and one or more software applications that run on the OS, to perform the operations described in this application. The hardware components may also access, manipulate, process, create, and store data in response to execution of the instructions or software. For simplicity, the singular term "processor" or "computer" may be used in the description of the examples described in this application, but in other examples multiple processors or computers may be used, or a processor or computer may include multiple processing elements, or multiple types of processing elements, or both, and thus while some references may be made to a singular processor or computer, such references also are intended to refer to multiple processors or computers. For example, a single hardware component or two or more hardware components may be implemented by a single processor, or two or more processors, or a processor and a controller. One or more hardware components may be implemented by one or more processors, or a processor and a controller, and one or more other hardware components may be implemented by one or more other processors, or another processor and another controller. One or more processors, or a processor and a controller, may implement a single hardware component, or two or more hardware components. As described above, or in addition to the descriptions above, example hardware components may have any one or more different processing configurations, examples of which include a single processor, independent processors, parallel processors, single-instruction single-data (SISD) multiprocessing, single-instruction multiple-data (SIMD) multiprocessing, multiple-instruction single-data (MISD) multiprocessing, and multiple-instruction multiple-data (MIMD) multiprocessing. Thus, references to a processor herein mean processing circuitry (e.g., circuitry that includes one or more processing element(s) circuits). One or more processors comprising processing circuitry also refers to each processor comprising processing circuitry, as well as some or all of the one or more processors comprising the same processing circuitry. In addition, processors(s) and controller(s), as a non-limiting example, do not mean human processing or human control, but rather, refer to hardware components as described herein, as non-limiting examples.

The methods illustrated in, and discussed with respect to, FIGS. 1-12 that perform the operations described in this application are performed by computing hardware, for example, by one or more processors or computers, implemented as described above implementing the instructions (e.g., computer or processor/processing device readable instructions) or software to perform the operations described in this application that are performed by the methods. For example, a single operation or two or more operations may be performed by a single processor, or two or more processors, or a processor and a controller. One or more operations may be performed by one or more processors, or a processor and a controller, and one or more other operations may be performed by one or more other processors, or another processor and another controller. One or more processors, or a processor and a controller, may perform a single operation, or two or more operations. References to a processor, or one or more processors, as a non-limiting example, configured to perform two or more operations refers to a processor or two or more processors being configured to collectively perform all of the two or more operations, as well as a configuration with the two or more processors respectively performing any corresponding one of the two or more operations (e.g., with a respective one or more processors being configured to perform each of the two or more operations, or any respective combination of one or more processors being configured to perform any respective combination of the two or more operations). Likewise, a reference to a processor-implemented method is a reference to a method that is performed by one or more processors or other processing or computing hardware of a device or system.

The instructions or software to control computing hardware, for example, one or more processors or computers, to implement the hardware components and perform the methods as described above may be written as computer programs, code segments, or other executable instructions or any combination thereof, for individually or collectively instructing or configuring the one or more processors or computers to operate as a machine or special-purpose computer to perform the operations that are performed by the hardware components and the methods as described above. In one example, the instructions or software include machine code that is directly executed by the one or more processors or computers, such as machine code produced by a compiler. In another example, the instructions or software includes higher-level code that is executed by the one or more processors or computer using an interpreter. The instructions or software may be written using any programming language based on the block diagrams and the flow charts illustrated in the drawings and the corresponding descriptions herein, which disclose algorithms for performing the operations that are performed by the hardware components and the methods as described above.

The instructions or software to control computing hardware, for example, one or more processors or computers, to implement the hardware components and perform the methods as described above, and any associated data, data files, and data structures, may be recorded, stored, or fixed in or on one or more non-transitory computer-readable storage media, and thus, not a signal per se. Thus, references herein to storage media mean storage media hardware, and does not mean to transitory media, nor a signal per se. As described above, or in addition to the descriptions above, examples of a non-transitory computer-readable storage medium include one or more of any of read-only memory (ROM), random-access programmable read only memory (PROM), electrically erasable programmable read-only memory (EEPROM), random-access memory (RAM), dynamic random access memory (DRAM), static random access memory (SRAM), flash memory, non-volatile memory, CD-ROMs, CD-Rs, CD+Rs, CD-RWs, CD+RWs, DVD-ROMs, DVD- Rs, DVD+Rs, DVD-RWs, DVD+RWs, DVD-RAMs, BD-ROMs, BD-Rs, BD-R LTHs, BD-REs, blue-ray or optical disk storage, hard disk drive (HDD), solid state drive (SSD), flash memory, a card type memory such as a multimedia card or a micro card (for example, secure digital (SD) or extreme digital (XD)), magnetic tapes, floppy disks, magneto-optical data storage devices, optical data storage devices, hard disks, solid-state disks, and/or any other device that is configured to store the instructions or software and any associated data, data files, and data structures in a non-transitory manner and provide the instructions or software and any associated data, data files, and data structures to one or more processors or computers so that the one or more processors or computers can execute the instructions. In one example, the instructions or software and any associated data, data files, and data structures are distributed over network-coupled computer systems so that the instructions and software and any associated data, data files, and data structures are stored, accessed, and executed in a distributed fashion by the one or more processors or computers.

While this disclosure includes specific examples, it will be apparent after an understanding of the disclosure of this application that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents.

Therefore, in addition to the above and all drawing disclosures, the scope of the disclosure is also inclusive of the claims and their equivalents, i.e., all variations within the scope of the claims and their equivalents are to be construed as being included in the disclosure.

What is claimed is:

1. A computer networking system comprising:
a host;
a switch connected to a root port of the host through an upstream port, the switch comprising a plurality of downstream ports; and
a plurality of endpoint devices connected to the switch and comprising a first endpoint device and a second endpoint device,
wherein the first endpoint device comprises:
a first target port connected to a first downstream port of the switch;
a second target port connected to a second downstream port different from the first downstream port; and
a controller configured to:
in response to receiving a request packet from the second endpoint device through the first target port, generate a response packet corresponding to the request packet,
measure a first congestion level for the first target port and a second congestion level for the second target port, and
transmit the response packet to the second endpoint device through an output port selected from among the first target port or the second target port based on a comparison of the measured first and second congestion levels.

2. The system of claim 1, wherein the controller is configured to:
match tag information included in the received request packet with tag information included in the generated response packet;
determine packet transmission latencies for the first and second target ports, respectively, based on the matched tag information; and
measure the first and second congestion levels based on the determined latencies.

3. The system of claim 1, wherein the controller is configured to measure the first and second congestion levels based on a number of response packets corresponding to request packets received from the second endpoint device, among the request packets transmitted from the first endpoint device to the second endpoint device.

4. The system of claim 1, wherein the controller is configured to:
determine one or both of first port identification information corresponding to the first target port and second port identification information corresponding to the second target port as output port identification information corresponding to the output port by inputting packets related to the first and second congestion levels into a decoder; and
store the output port identification information in a lookup table based on configuration information received from the host.

5. The system of claim 1, wherein the first endpoint device is configured to generate tag information based on a generation time point of each of a plurality of response packets comprising the response packet.

6. The system of claim 5, wherein
the first endpoint device is configured to, in response to receiving another request packet from the second endpoint device after receiving the request packet, generate another response packet corresponding to the other request packet and generate additional tag information based on a generation time point of the other response packet, and
the controller is configured to align transmission time points of the response packet and the other response packet to another endpoint device based on the tag information and the additional tag information.

7. The system of claim 1, wherein at least one of the first target port or the second target port comprises:
a first sub-port comprising a first transaction layer, a first data link layer, and a first physical layer, and configured to transmit configuration information received from the host to an internal register; and
a second sub-port comprising a second transaction layer and a second data link layer.

8. The system of claim 1, wherein the second endpoint device is configured to:
generate metadata comprising source information corresponding to the second endpoint device and destination information corresponding to the first endpoint device; and
transmit the generated metadata and the request packet to the first endpoint device.

9. The system of claim 8, wherein
the first endpoint device is configured to transmit the request packet and the metadata to the second endpoint device through the output port, and
the second endpoint device is configured to track a peer-to-peer communication path between the first and second endpoint devices based on the metadata.

10. The system of claim 8, wherein
the source information comprises identification information corresponding to the second endpoint device and a target port included in the second endpoint device, and
the destination information comprises identification information corresponding to the first endpoint device and a target port included in the first endpoint device.

11. A computer networking method comprising:
receiving, by a first endpoint device comprising a first target port and a second target port, a request packet from a second endpoint device through the first target port;
generating, by the first endpoint device, a response packet corresponding to the request packet;
measuring, by a controller included in the first endpoint device, a first congestion level corresponding to the first target port and a second congestion level corresponding to the second target port;
selecting, by the controller, an output port from among the first target port and the second target port based on a comparison of the measured first and second congestion levels; and
transmitting, by the controller, the response packet to the second endpoint device through the selected output port.

12. The method of claim 11, wherein the measuring of the first and second congestion levels comprises:
matching tag information included in the received request packet with tag information included in the generated response packet;
determining packet transmission latencies for the first and second target ports, respectively, based on the matched tag information; and
measuring the first and second congestion levels based on the determined latencies.

13. The method of claim 11, wherein the measuring of the first and second congestion levels comprises:
measuring the first and second congestion levels based on a number of response packets corresponding to request packets received from the second endpoint device, among the request packets transmitted from the first endpoint device to the second endpoint device.

14. The method of claim 11, wherein the selecting of the output port comprises:
determining one or both of first port identification information corresponding to the first target port and second port identification information corresponding to the second target port as output port identification information corresponding to the output port by inputting packets related to the first and second congestion levels into a decoder; and
storing, by the controller, the output port identification information in a lookup table based on configuration information received from the host.

15. The method of claim 11, further comprising:
generating, by the first endpoint device, tag information based on a generation time point of the response packet.

16. The method of claim 15, further comprising:
in response to receiving another request packet from the second endpoint device after a time point of receiving the request packet, generating, by the first endpoint device, another response packet corresponding to the other request packet;
generating, by the first endpoint device, additional tag information based on a generation time point of the other response packet; and
aligning, by the controller, transmission time points of the response packet and the other response packet to another endpoint device based on the tag information and the additional tag information.

17. The method of claim 11, further comprising:
generating, by the second endpoint device, metadata comprising source information corresponding to the second endpoint device and destination information corresponding to the first endpoint device; and
transmitting, by the second endpoint device, the generated metadata and the request packet to the first endpoint device.

18. The method of claim 17, further comprising:
transmitting, by the first endpoint device, the request packet and the metadata to the output port; and
tracking, by the second endpoint device, a peer-to-peer communication path between the first and second endpoint devices based on the metadata.

19. The method of claim 17, wherein the generating of the metadata comprises:
generating, by the second endpoint device, source information comprising identification information corresponding to the second endpoint device and a target port included in the second endpoint device; and
generating, by the second endpoint device, destination information comprising identification information corresponding to the first endpoint device and a target port included in the first endpoint device.

20. A non-transitory computer-readable storage medium storing instructions that, when executed by one or more processors, cause the one or more processors to perform the method of claim 11.
